(19) United States
(12) Patent Application Publication
(10) Pub. No.: US 2014/0125273 A1
(43) Pub. Date: May 8, 2014

(54) CONTROL SYSTEM AND METHOD FOR BATTERY

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: SONG-LIN TONG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/014,298

(22) Filed: Aug. 29, 2013

(30) Foreign Application Priority Data
Nov. 8, 2012 (CN) 2012104434284

(51) Int. Cl. H02J 7/00

(52) U.S. Cl. CPC H02J 7/007
USPC 320/107; 320/134

(57) ABSTRACT

A control system for a battery includes a battery backup unit (BBU), a switch circuit coupled between the BBU and the adapter, and a complex programmable logic device (CPLD) coupled to the BBU and the switch circuit. The CPLD controls the switch circuit to turn on when an actual rate between a rest voltage and a rated voltage of the battery is less than a predetermined rate, to charge the battery through the switch circuit. If the actual rate is greater than or equal to the predetermined rate, the CPLD maintains the adapter to charge or discharge the battery according to state of the battery.

### BACKGROUND

1. Technical Field

The present disclosure relates to a control system for a battery.

2. Description of Related Art

Portable devices use batteries as a power source. While lifetime of the battery is strongly related with charge times of the battery, the more times the battery charges, the shorter life time the battery has. However, the battery automatically charges when the portable device is connected to an external power source, even if the power of the battery may operate for a long time for the portable device. This will shorten the life time of the battery.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a control system for a battery of the present disclosure, where the control system includes a first switch circuit and a second switch circuit.

FIG. 2 is a circuit diagram of the first and second switch circuits of FIG. 1.

FIG. 3 is a flowchart of an embodiment of a control method for a battery of the present disclosure.

### DETAILED DESCRIPTION

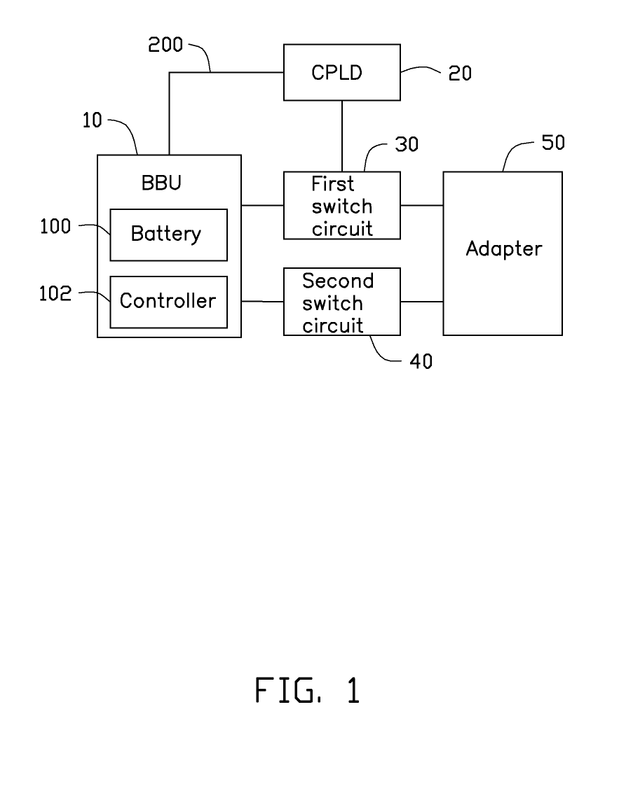

FIG. 1 is a block diagram of an embodiment of a control system 800 for a battery of the present disclosure, where the control system includes a first switch circuit 30 and a second switch circuit 40 The control system 800 further includes an adapter 50, a battery backup unit (BBU) 10 where the first switch circuit 30 coupled between the adapter 50 and the BBU 10, a complex programmable logic device (CPLD) 20 coupled to the BBU 10 and the first switch circuit 30, and the second switch circuit 40 coupled between the BBU 10 and the adapter 50.

The adapter 50 converts an alternating current (AC) power source into a direct current (DC) power source when the adapter 50 is connected to the AC power source.

The BBU 10 includes a battery 100 and a controller 102. The controller 102 transmits a rest voltage and a rated voltage of the battery 100 and state of the battery 100 to the CPLD 20. In the embodiment, the controller 102 obtains the state of the battery 100, such as a charge state or a discharge state. The controller 102 controls the battery 100 to charge when the controller 102 receives a voltage. In the embodiment, the controller 102 is a microprocessor.

The CPLD 20 is connected to the BBU 10, to obtain the rest voltage, the rated voltage, and the state of the battery 100. The CPLD 20 further determines whether to output a control signal to the first switch circuit 30 according to a predetermined rate about the rest voltage and the rated voltage of the battery 100 and the state of the battery 100. For example, if the predetermined rate is 30 percent of the rated voltage of the battery 100 pre-defined by a user, that is a rate between the rest voltage and the rated voltage of the battery 100 is 0.3. When the rate between the rest voltage and the rated voltage is less than the predetermined rate, the CPLD 20 outputs a high level control signal, such as logic 1, to the first switch circuit 30. The first switch circuit 30 is turned on, thereby enabling the adapter 50 to charge the battery 100 of the BBU 10. When the rate between the rest voltage and the rated voltage is greater than or equal to 0.3, and the battery 100 is in a charge state, the CPLD 20 keeps outputting the high level control signal to the first switch circuit 30 until the battery 100 charges fully. While the rate between the rest voltage and the rated voltage is greater than or equal to 0.3, and the battery 100 is in a discharge state. The CPLD 20 outputs a low level control signal, such as logic 0, to turn off the first switch circuit 30, thereby disconnecting the adapter 50 from the battery 100 to avoid charging the battery 100. In the embodiment, the CPLD 20 obtains the rest voltage, the rated voltage, and the state of the battery 100 through an inter-integrated circuit (I2C) bus 200.

On a condition that the predetermined rate is very small, such as 5 percent of the rated voltage of the battery 100, it indicates that the predetermined rate may be unreasonable. For example, if the predetermined rate is less than a safe rate of the battery 100, the BBU 100 will still output voltage until the rest voltage is less than a voltage corresponding to the small predetermined rate, which can cause damage to the battery 10. In order to avoid the battery 10 from damage of the unreasonable predetermined rate, the second switch circuit 40 is automatically turned on when an actual rate between the rest voltage and the rated voltage of the battery 100 is less than the safe rate. Thereby enabling the adapter 50 to provide voltage to the battery 100 through the second switch circuit 40, to charge the battery 100.

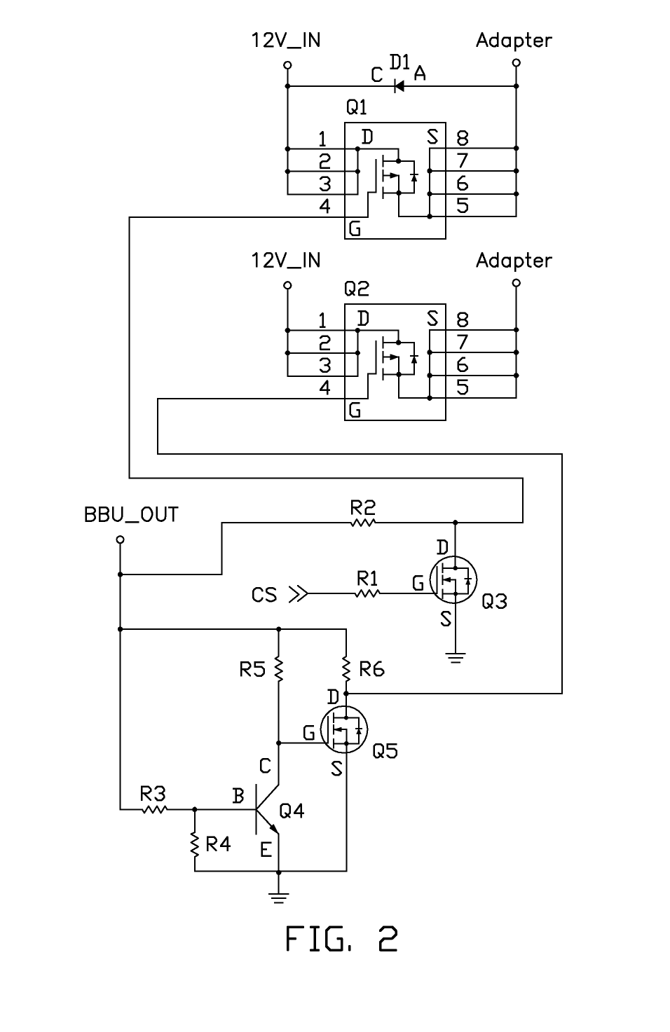

FIG. 2 shows that the first electronic switch circuit 30 includes two electronic switches Q1 and Q3, and two resistors R1 and R2. A first terminal of the electronic switch Q3 is coupled to the CPLD 20 through the resistor R1, to receive the control signal from the CPLD 20. A second terminal of the electronic switch Q3 is grounded. A third terminal of the electronic switch Q3 is coupled to a voltage output terminal BBU_OUT of the BBU 10 through the resistor R2, and is coupled to a first terminal of the electronic switch Q1. A second terminal of the electronic switch Q1 is coupled to a charging terminal Adapter of the adapter 50. A third terminal of the electronic switch Q1 is coupled to a voltage input terminal 12V_IN of the BBU 10. When the first terminal of the electronic switch Q3 is at a high level, the electronic switch Q3 is turned on, and when the first terminal of the electronic switch Q3 is at a low level, the electronic switch Q3 is turned off. When the first terminal of the electronic switch Q1 is at a high level, the electronic switch Q1 is turned off, and when the first terminal of the electronic switch Q1 is at a low level, the electronic switch Q1 is turned on. In the embodiment, the electronic switch Q1 a is p-channel power metal oxide semiconductor field effective transistor (PMOSFET), where a gate, a source, and a drain of the PMOSFET are respectively the first, the second, and the third terminals of the electronic switch Q1. The electronic switch Q3 is an n-channel metal oxide semiconductor field effective transistor (NMOSFET), where a gate, a source, and a drain of the NMOSFET are respectively the first, the second, and the third terminals of the electronic switch Q3.

The second switch circuit 40 includes there electronic switches Q2, Q4, and Q5, and four resistors R3-R6. A first terminal of the electronic switch Q4 is coupled to the voltage output terminal BBU_OUT of the BBU 10 through the resistor R3. A second terminal of the electronic switch Q4 is grounded, and is coupled to the first terminal of the electronic switch Q4 through the resistor R4. A third terminal of the electronic switch Q4 is coupled to a first terminal of the electronic switch Q5. The first terminal of the electronic switch Q5 is also coupled to the voltage output terminal BBU_OUT of the BBU 10 through the resistor R5. A second terminal of the electronic switch Q5 is grounded. A third terminal of the electronic switch Q5 is coupled to the voltage output terminal BBU_OUT of the BBU 10 through the resistor R6, and is coupled to a first terminal of the electronic switch Q2. A second terminal of the electronic switch Q2 is coupled to the charging terminal adapter of the adapter 50. A third terminal of the electronic switch Q2 is coupled to the voltage input terminal 12V_IN of the BBU 10. When the first terminals of the electronic switches Q4 and Q5 are at a high level, the electronic switches Q4 and Q5 are turned on, and when the first terminals of the electronic switches Q4 and Q5 are at a low level, the electronic switch Q4 and Q5 are turned off. When the first terminal of the electronic switch Q2 is at a high level, the electronic switch Q2 is turned off, and when the first terminal of the electronic switch Q2 is at a low level, the electronic switch Q2 is turned on. In the embodiment, the electronic switch Q5 is an NMOSFET, where a gate, a source, and a drain of the NMOSFET are respectively the first, the second, and the third terminals of the electronic switch Q5. The electronic switch Q2 is a PMOSFET, where a gate, a source, and a drain of the PMOSFET are respectively the first, the second, and the third terminals of the electronic switch Q2. The electronic switch Q4 is an npn transistor, where a base, an emitter, and a collector of the npn transistor are respectively the first, the second, and the third terminals of the electronic switch Q4.

The CPLD 20 determines whether the predetermined rate is less than the safe rate. If the predetermined rate is greater than or equal to the safe rate, the CPLD 20 further determines whether the actual rate between the rest voltage and the rated voltage of the battery 100 is less than the predetermined rate. If the actual rate is less than the predetermined rate, the CPLD 20 outputs the high level control signal to the first terminal of the electronic switch Q3. The electronic switch Q3 is turned on, and the third terminal of the electronic switch Q3 is at a low level, so does the first terminal of the electronic switch Q1. The electronic switch Q1 is turned on. Hence, the adapter 50 outputs voltage to the voltage input terminal 12V_IN of the BBU 10 through the charging terminal of the adapter 50. The controller 102 then controls the battery 100 to charge. In a meanwhile, the BBU 10 outputs voltage through the voltage output terminal BBU_OUT. The first terminal of the electronic switch Q4 of the second switch circuit 40 is at a high level, and the electronic switch Q4 is turned on. The third terminal of the electronic switch Q4 is at a low level, so does the first terminal of the electronic switch Q5. The electronic switch Q5 is turned off. Accordingly, the adapter 50 provides voltage to the BBU 10 through the first electronic switch 30, but not the second electronic switch circuit 40. When the actual rate between the rest voltage and the rated voltage is greater than or equal to the predetermined rate, and if the CPLD 10 determines that the battery 100 is in the charge state. The CPLD 10 outputs the high level control signal to the first switch circuit 30, thereby maintaining the adapter 50 providing voltage to the BBU 10 through the first switch circuit 30. Alternatively, when the actual rate between the rest voltage and the rated voltage is greater than or equal to the predetermined rate, and if the CPLD 10 further determines that the battery 100 is in the discharge state. The CPLD 10 outputs the low level control signal to the first terminal of the electronic switch Q3 of the first switch circuit 30. The electronic switch Q3 is turned off, and the third terminal of the electronic switch Q3 is at a high level, so the first terminal of the electronic switch Q1 closes. The electronic switch Q1 is turned off. Accordingly, the adapter 50 cannot provide voltage to the BBU 10 through the first switch circuit 30, avoiding the charging of the battery 100, thus, decreasing charge times of the battery 100.

When the CPLD 20 determines that the predetermined rate is less than the safe rate, it indicates that the predetermined rate may be unreasonable. For example, the predetermined rate may be defined as 0.05 by a user, while the safe rate of the battery 100 may be 0.1. The CPLD 20 then determines whether the actual rate is less than the safe rate. If the actual rate is less than the safe rate and greater than the predetermined rate, when the voltage output by the BBU 10 through the voltage output terminal BBU_OUT is decreasing, the electronic switch Q4 is turned off on a condition that the voltage of the first terminal of the electronic switch Q4 is at a low level, such as logic 0. The first terminal of the electronic switch Q5 is at a high level, and the electronic switch Q5 is turned on. The third terminal of the electronic switch Q5 is at a low level, so is the first terminal of the electronic switch Q2. The electronic switch Q2 is turned on, so that the adapter 10 can provide voltage through the second switch circuit 40, and the controller 102 controls the battery 100 to charge. Accordingly, the adapter 50 can still provide voltage to the BBU 10 through the second switch circuit 40 even though the predetermined rate is unreasonable, which may avoid the battery 100 from being damage. In the meanwhile, the CPLD 20 further determines whether the adapter 50 charges the battery 100 of the BBU 10 for a predetermined time. The CPLD 20 further outputs the high level control signal to the first switch circuit 30 at the end of the first predetermined time, to control the adapter 50 to charge the battery 100 through the first switch circuit 30. The voltage of the first terminal of the electronic switch Q4 will become greater and greater during the predetermined time. When the voltage of the first terminal of the electronic switch Q4 reaches a high level, the electronic switch Q4 is turned on, the electronic switch Q5 is turned off, and the electronic switch Q2 is turned off, so that the second electronic switch circuit 40 will not provide the charge routine for the adapter 50. Accordingly, the CPLD 20 outputs the high level control signal to the first switch circuit 30 before the second switch circuit 40 is turned off, controlling the adapter 50 to charge the battery 100 of the BBU 10 through the first switch circuit 30.

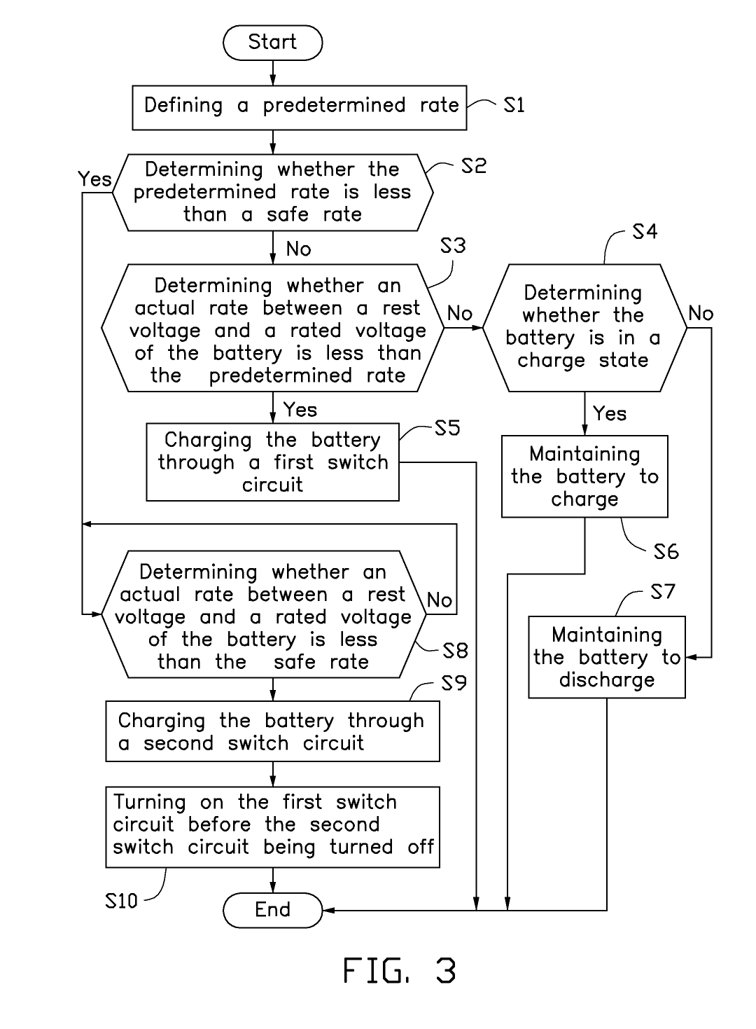

FIG. 3 shows a control method for the battery 100 of the present disclosure. The control method includes the following steps.

In step S1, a predetermined rate is pre-defined.

In step S2, the CPLD 20 determines whether the predetermined rate is less than the safe rate of the battery 100. If the predetermined rate is less than the safe rate of the battery 100, step S8 is implemented. Otherwise, if the predetermined rate is greater than or equal to the safe rate, step S3 is implemented.

In step S3, the CPLD 20 determines whether the actual rate between the rest voltage and the rated voltage of the battery 100 is less than the predetermined rate. If the actual rate is less than the predetermined rate, step S5 is implemented. Otherwise, if the actual rate is greater than or equal to the predetermined rate, step S4 is implemented.

In step S4, the CPLD 20 determines whether the battery 100 is in the charge state. If the battery 100 is in the charge state, step S6 is implemented. Otherwise, if the battery 10 is in the discharge state, step S7 is implemented.

In step S5, the CPLD 20 outputs the high level control signal to the first switch circuit 30, to enable the adapter 50 to charge the battery 100 through the first switch circuit.

In step S6, the CPLD 20 keeps outputting the high level control signal to the first switch circuit 30, thereby maintaining the battery 100 in the charge state.

In step S7, the CPLD 20 outputs the low level control signal to the first switch circuit 30, thereby maintaining the battery 100 in the discharge state.

In step S8, the CPLD 20 determines if the actual rate is less than the safe rate. When the actual rate is less than the safe rate, step S9 is implemented. Otherwise, if the actual rate is greater than or equal to the safe rate, step S8 is repeated.

In step S9, the second switch circuit 40 is turned on automatically, thereby enabling the adapter 50 to charge the battery 100 through the second switch circuit 40.

In step S10, the CPLD 20 outputs the high level control signal to the first switch circuit 30 before the second switch circuit 40 is turned off, to control the adapter 50 to charge the battery 100 through the first switch circuit 30.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A control system, comprising:
an adapter converting an alternating current (AC) power into a direct current (DC) power;
a battery backup unit (BBU) coupled to the adapter through a voltage input terminal, and outputting voltage through a voltage output terminal, the BBU comprising a battery and a controller;
a first switch circuit coupled between the BBU and the adapter, wherein when the first switch circuit receives a high level control signal, the first switch circuit is turned on, and when the first switch circuit receives a low level control signal, the first switch circuit is turned off; and
a complex programmable logic device (CPLD) coupled to the BBU and the first switch circuit;
wherein the CPLD obtains a rest voltage, a rated voltage, and state of the battery of the BBU, the CPLD determines whether an actual rate between the rest voltage and the rated voltage is less than a predetermined rate; the CPLD outputs a low level control signal to the first switch circuit in response to the actual rate being less than the predetermined rate and the battery being in a discharge state, the adapter charges the battery through the first switch circuit; the CPLD outputs a high level control signal to the first switch circuit in response to the actual rate being greater than or equal to the predetermined rate and the battery being in a charge state.

2. The control system of claim 1, wherein when the actual rate is less than the predetermined rate, the CPLD outputs the high level control signal to the first switch circuit, to control the adapter to charge the battery of the BBU through the first switch circuit.

3. The control system of claim 2, further comprising a second switch circuit coupled between the adapter and the BBU, wherein when the first switch circuit is turned on, the second switch circuit is turned off; if the predetermined rate is less than a safe rate corresponding to the battery, and when the actual rate is less than the safe rate, the second switch circuit is turned on, the adapter charges the battery through the second switch circuit.

4. The control system claim 3, wherein when the second switch circuit is turned on for a predetermined time, the CPLD outputs the high level control signal to the first switch circuit, to enable the first switch circuit to be turned on before the second switch circuit is turned off.

5. The control system of claim 4, wherein the second switch circuit comprises first to fourth resistors, first to third electronic switches; a first terminal of the first electronic switch is coupled to the voltage output terminal of the BBU through the first resistor, and is grounded through the second resistor, a second terminal of the first electronic switch is grounded, a third terminal of the first electronic switch is coupled to the voltage output terminal of the BBU through the third resistor, and is coupled to a first terminal of the second electronic switch; a second terminal of the second electronic switch is grounded, a third terminal of the second electronic switch is coupled to the voltage output terminal of the BBU through the fourth resistor, and is coupled to a first terminal of the third electronic switch; a second terminal of the third electronic switch is coupled to the adapter, a third terminal of the third electronic switch is coupled to the voltage input terminal of the BBU; when first terminals of the first and second electronic switches are at high levels, the second terminals of the first and second electronic switches are connected to the corresponding third terminals; when first terminals of the first and second electronic switches are at low levels, the second terminals of the first and second electronic switches are disconnected to the corresponding third terminals; when the first terminal of the third electronic switch is at low level, the second terminal of the third electronic switch is connected to the third terminal of the third electronic switch; when the first terminal of the third electronic switch is at high level, the second terminal of the third electronic switch is disconnected to the third terminal of the third electronic switch.

6. The control system of claim 5, wherein first switch circuit comprises fifth and sixth resistors, and fourth and fifth electronic switches; a first terminal of the fourth electronic switch is coupled to the CPLD through the fifth resistor, to receive the control signal from the CPLD, a second terminal of the fourth electronic switch is grounded, a third terminal of the fourth electronic switch is coupled to the voltage output terminal of the BBU through the sixth resistor, and is coupled to a first terminal of the fifth electronic switch; a second terminal of the fifth electronic switch is coupled to the adapter, a third terminal of the fifth electronic switch is coupled to the voltage input terminal of the BBU; when the first terminal of the fourth electronic switch is at high level, the second terminal of the fourth electronic switch is connected to the third terminal of the fourth electronic switch; when the first terminal of the fourth electronic switch is at low level, the second terminal of the fourth electronic switch is disconnected from the third terminal of the fourth electronic switch; when the first terminal of the fifth electronic switch is at low level, the second terminal of the fifth electronic switch is connected to the third terminal of the fifth electronic switch; when the first terminal of the fifth electronic switch is at high level, the second terminal of the fifth electronic switch is disconnected from the third terminal of the fifth electronic switch.

7. The control system of claim 6, wherein the first electronic switch is an npn transistor, wherein a base, an emitter, and a collector of the npn transistor are respectively the first, the second, and the third terminals of the first electronic switch.

8. The control system of claim 6, wherein the second and fourth electronic switches are n-channel metal oxide semiconductor field effective transistors (NMOSFETs), wherein gates, sources, and drains of the NMOSFETs are the first, the second, and the third terminals of the second and fourth electronic switches.

9. The control system of claim 6, wherein the third and fifth electronic switches are p-channel metal oxide semiconductor field effective transistors (PMOSFETs), wherein gates, sources, and drains of the PMOSFETs are the third and fifth electronic switches.

10. A control method for a battery, comprising:
defining a predetermined rate;
determining whether an actual rate between a rest voltage and a rated voltage of the battery is less than the predetermined rate;
controlling a first switch circuit to turn on and charging the battery through the first switch circuit in response to the actual rate is less than the predetermined rate;
determining whether the battery is in a charge state in response to the actual rate being greater than or equal to the predetermined rate;
maintaining the battery to charge through the first switch circuit in response to the battery being in the charge state; and
maintaining the battery to discharge in response to the battery being in a discharge state.

11. The control method of claim 10, after the step of “defining a predetermined rate” comprising:
determining whether the predetermined rate is less than a safe rate of the battery;
determining whether the actual rate is less than the safe rate in response to the predetermined rate being less than the safe rate;
charging the battery through a second switch circuit automatically in response to the actual rate being less than the safe rate.

12. The control method of claim 11, further comprising:
turning on the first switch circuit in response to the second switch circuit being turned on for a predetermined time.

13. The control method of claim 12, wherein the second switch circuit is turned off after the predetermined time.
